(19) United States
(12) Patent Application Publication
(10) Pub. No.: US 2008/0236032 A1
(43) Pub. Date: Oct. 2, 2008

(54) Compositions, devices and methods for hydrogen generation

(76) Inventors: Michael T. Kelly, Plainsboro, NJ (US); Jeffrey V. Ortega, Township of Lacey, NJ (US)

Correspondence Address: DICKSTEIN SHAPIRO LLP, 1825 EYE STREET NW, Washington, DC, 20006-5403, US

(21) Appl. No.: 11/892,517

(22) Filed: Aug. 23, 2007

Related U.S. Application Data
(60) Provisional application No. 60/907,232, filed on Mar. 26, 2007.

(51) Int. Cl. C10L 5/00; B01J 19/00; C01B 3/02

(52) U.S. Cl. 44/628; 422/165; 423/648.1

(57) ABSTRACT

Hydrogen storage fuel compositions and devices comprising a mixture of at least one chemical hydride compound and at least one proton source, and methods for thermally initiated hydrogen generation from fuel compositions are disclosed. The fuel compositions comprise an excess of hydridic hydrogens relative to protic hydrogens. Fuel cartridges suitable for use with compositions which generate hydrogen upon the application of thermal initiation and methods for operating the fuel cartridges are also disclosed.

### CROSS-REFERENCE TO RELATED APPLICATIONS

This application claims the benefit of U.S. Provisional Application Ser. No. 60/907,232, filed Mar. 26, 2007, the entire disclosure of which is incorporated herein by reference.

### FIELD OF THE INVENTION

The present invention relates to hydrogen storage compositions and methods for thermally initiating hydrogen generation from hydrogen storage compositions.

### BACKGROUND OF THE INVENTION

There is an ongoing need for new energy and power sources to meet the growing demand for portable power. Fuel cells are being considered as replacements for batteries. A fuel cell for small applications needs to be compact and lightweight and have a high energy storage density.

Hydrogen is the fuel of choice for fuel cells. Their adoption is dependent on finding a convenient and safe hydrogen source due to difficulties in storing the gas. Various nongaseous hydrogen carriers, including hydrocarbons, metal hydrides, and chemical hydrides are being considered as hydrogen storage and supply systems.

Representative compositions developed for hydrogen generation from solid mixtures of chemical hydrides and hydroxide compounds as in US Pat. Appl. Publ. 2005/0191232 A1 require the two components to be combined in ratios that contain equimolar amounts of hydrogen atoms (the number of hydrogen atoms is determined by the product of xy in Equation 1 below) in the chemical hydride (MHₓ) and hydroxide (N(OH)_{y}) components as shown in Eq. (1), wherein M and N represent different cationic species:

yMHₓ+xN(OH)_{y}→xyH₂+(xy/2)N_{(2/x)}O+(xy/2)N_{(2/y)}O Eq. (1)

These blends have not been demonstrated to release all of the theoretical stored hydrogen, and are reported to release only about 20 to 80% of the theoretical hydrogen unless a catalyst is added to the composition.

There is a need for hydrogen generation systems that are compact and that minimize the presence of gaseous hydrogen while providing favorable hydrogen storage metrics. Hydrogen generation systems, wherein operating demands of the fuel cell are matched to control of the flow rate and pressure of the system, are also needed.

### BRIEF SUMMARY OF THE INVENTION

The invention provides hydrogen storage compositions and heat-activated methods of hydrogen generation in which the generation of hydrogen is initiated by the application of heat to hydrogen storage compositions. The present invention also provides fuel cartridges suitable for use with the compositions and methods disclosed herein. The methods and compositions provide hydrogen generation systems that minimize the presence of gaseous hydrogen by producing hydrogen on an as-needed basis.

### BRIEF DESCRIPTION OF THE DRAWINGS

A complete understanding of the invention may be obtained by reference to the accompanying drawings when considered in conjunction with the following detailed description, in which:

FIGS. 1A and 1B are cross sectional views of exemplary fuel cartridges in accordance with an embodiment of the invention.

FIG. 2 is a cross sectional view of a fuel compartment arrangement according to an embodiment of the invention.

FIG. 3 is an illustration of a multi-layer arrangement of hydrogen storage compositions in accordance with an embodiment of the invention.

FIGS. 4A, 4B, and 4C are top views of geometric arrangements of fuel compartments useful in embodiments of the invention.

FIGS. 5A and 5B are views of a fuel compartment arrangement according to an embodiment of the invention.

FIGS. 6A, 6B, and 6C illustrate alternate arrangements of initiation elements useful in embodiments of the invention.

### DETAILED DESCRIPTION OF THE INVENTION

The invention provides solid hydrogen storage compositions comprising at least one chemical hydride and at least one proton source, thermally-initiated methods of hydrogen generation in which the generation of hydrogen is initiated by the application of heat to a mixture comprising at least one chemical hydride compound and at least one proton source, and fuel cartridges suitable for use with the compositions and methods disclosed herein. Hydrogen is generated from the hydrogen storage compositions when heat is applied to the mixture. Initiation elements suitable for use in the invention include, but are not limited to, resistance heaters, nickel-chromium resistance wires, spark igniters, thermistors, and heat exchangers, among others. The heating can be achieved, for example, by placing the materials in a reactor and heating the reactor, or by a heating element in contact with the hydrogen storage compositions.

One embodiment of the invention provides a solid fuel composition for generating hydrogen comprising (i) at least one chemical hydride having at least one hydridic hydrogen, and (ii) at least one proton source having at least one protic hydrogen, wherein the at least one chemical hydride and the at least one proton source are combined such that there are more hydridic hydrogens than protic hydrogens on a molar basis.

In an embodiment of the invention, solid fuel compositions are provided that comprise an aluminum hydride salt having the general formula M(AlH₄)ₙ, where M is selected from the group consisting of alkali metal cations, alkaline earth metal cations, aluminum cation, zinc cation, and ammonium cation, and is preferably sodium or lithium, and n is equal to the charge of the cation. Preferably, the proton source is aluminum hydroxide or boric acid.

In another embodiment, the invention provides a process for generating hydrogen. The method comprises (i) providing a solid fuel composition of at least one chemical hydride and at least one proton source and (ii) using thermal initiation to generate hydrogen.

In another embodiment, the invention provides a fuel cartridge that can provide hydrogen to a power module comprising a fuel cell or hydrogen-burning engine for conversion to energy, or to a hydrogen storage device such as a hydrogen cylinder, a metal hydride, or a balloon. The fuel cartridge comprises a housing containing a plurality of fuel compartments; and at least one initiation element in communication with at least one fuel compartment.

Another embodiment of the invention provides a fuel cartridge that can provide hydrogen to a power module comprising a fuel cell or hydrogen-burning engine for conversion to energy, or to a hydrogen storage device such as a hydrogen cylinder, a metal hydride, or a balloon. The fuel cartridge comprises a housing containing a plurality of fuel compartments with porous walls and at least one initiation element in communication with at least one fuel compartment.

In another embodiment of the invention, methods are provided for operating a fuel cartridge comprising a housing containing a plurality of fuel compartments, at least one initiation element in communication with at least one fuel compartment, and a fuel which generates hydrogen with thermal initiation.

The term “solid” as used herein encompasses any nongaseous and nonliquid form, including powders, caplets, tablets, pellets, granules, rods, fibers, crystals, and monoliths, for example.

Suitable chemical hydrides include, but are not limited to, boron hydrides, ionic hydride salts, and aluminum hydrides. These chemical hydrides may be utilized in mixtures or individually. The hydrogen atoms contained within the chemical hydrides are referred to herein as “hydridic hydrogens,” and can be represented as “H.⁻” A hydridic hydrogen is a hydrogen atom bound to an element less electronegative than hydrogen on the Pauling scale or is bound to Ru, Rh, Pd, Os, Ir, Pt, Au, or As.

As used herein, the term “boron hydrides” includes boranes, polyhedral boranes, and anions of borohydrides or polyhedral boranes. Suitable boron hydrides include, without intended limitation, the group of borohydride salts [M(BH₄)ₙ], triborohydride salts [M(B₃H₈)ₙ], decahydrodecaborate salts [M₂(B₁₀H₁₀)ₙ], tridecahydrodecaborate salts [M(B₁₀H₁₃)ₙ], dodecahydrododecaborate salts [M₂(B₁₂H₁₂)ₙ], and octadecahydroicosaborate salts [M₂(B₂₀H₁₈)ₙ], where M is an alkali metal cation, alkaline earth metal cation, aluminum cation, zinc cation, or ammonium cation, and n is equal to the charge of the cation. For the above-mentioned boron hydrides, M is preferably sodium, potassium, lithium, or calcium. Suitable borane hydrides also include, without intended limitation, neutral borane compounds, such as decaborane(14) (B₁₀H₁₄), tetraborane(10) (B₄H₁₀), and ammonia borane compounds. As used herein, the term “ammonia boranes” includes compounds containing N—H and B—H bonds such as (a) compounds represented by formula NHₓBH_{y}, wherein x and y are independently an integer from 1 to 4 and do not have to be the same, including NH₃BH₃; (b) compounds represented by formula NHₓRBH_{y}, wherein x and y are independently an integer from 1 to 4 and do not have to be the same, and R is a methyl or ethyl group; (c) NH₃B₃H₇; and (d) dimethylamine borane (NH(CH₃)₂BH₃), for example.

Ionic hydrides include, without intended limitation, zinc hydride and the hydrides of alkali metals and alkaline earth metals having the general formula MHₙ wherein M is a cation selected from the group consisting of alkali metal cations such as sodium, potassium or lithium and alkaline earth metal cations such as magnesium or calcium, and n is equal to the charge of the cation. Examples of suitable metal hydrides, without intended limitation, include lithium hydride, sodium hydride, magnesium hydride, calcium hydride, zinc hydride, and the like.

Aluminum hydrides include, for example, alane (AlH₃) and the aluminum hydride salts including, without intended limitation, salts with general formula M(AlH₄)ₙ, where M is an alkali metal cation, alkaline earth metal cation, aluminum cation, zinc cation, or ammonium cation, and n is equal to the charge of the cation.

Optionally, the boron or other chemical hydride fuel component may be combined with a stabilizer agent selected from the group consisting of metal hydroxides, anhydrous metal metaborates, and hydrated metal metaborates, and mixtures thereof. Solid stabilized fuel compositions comprising about 20 to about 99.7 wt-% borohydride and about 0.3 to about 80 wt-% hydroxide salts are disclosed in co-pending U.S. patent application Ser. No. 11/068,838 entitled “Borohydride Fuel Composition and Methods” and filed on Mar. 2, 2005, the disclosure of which is incorporated by reference herein in its entirety.

As used herein, the term “proton source” means a compound that has at least one “protic hydrogen” that can be represented as “H⁺”; a protic hydrogen is a hydrogen atom bound to an element more electronegative than hydrogen on the Pauling scale or is bound to Te.

Solid proton sources useful in embodiments of the invention include, for example, hydroxide salts of alkali and alkaline earth metals; alkali metal dihydrogen phosphate salts; alkali metal dihydrogen citrate salts; alcohols; polymeric alcohols; silicates; silica sulfuric acid; acid chloride compounds; hydrogen sulfide; amines; solid state acids with the general formula M_{y}[OₚX(OH)_{q}]ₙ where X is S, P, or Se, M is an alkali metal or NH₄, q is an integer from 0 to 3, p is an integer from 0 to 3, y is the valence of the anion [OₚX(OH)_{q}], and n is the valence of M; sulfate and phosphate salts of alkali and alkaline earth metals; and hydroxide compounds of Group 13 elements. Representative examples of proton sources include, but are not limited to, boric acid, aluminum hydroxide, lithium hydroxide, sodium hydroxide, potassium hydroxide, cesium hydroxide, magnesium hydroxide, sodium dihydrogen phosphate (NaH₂PO₄), Si(OH)₄, sodium dihydrogen citrate (C₆H₇NaO₇), polyvinyl alcohol; sodium sulfate, sodium phosphate, Si(OH)₄, CsHSO₄, CsHSeO₄, and CsH₂PO₄. Representative examples of hydrogen storage compositions in accordance with embodiments of the invention are provided in Table 1.

TABLE 1

| Compositions | wt-% H₂ | ΔH(300° C.) | Eqn. |
|---|---|---|---|
| 4LiAlH₄ + 2Al(OH)₃ → 3LiAlO₂ + | 6.87 | −705 kJ | 1 |
| 3Al + LiH + 10.5H₂ | | | |
| 4BH₃NH₃ + 4LiAlH₄ + 2Al(OH)₃ → | 10.67 | −1202 kJ | 2 |
| 3LiAlO₂ + 3Al + LiH + 4BN + 22.5H₂ | | | |
| 2MgH₂ + LiBH₄ + Si(OH)₄ → SiO₂ + | 7.09 | −82 kJ | 3 |
| LiBO₂ + 2Mg + 6H₂ | | | |
| 2LiAlH₄ + NaHSO₄ → NaLiSO₄ + | 4.11 | −139 kJ | 4 |
| 2Al + LiH + 4H₂ | | | |
| 2MgH₂ + 2NaH + NaH₂PO₄ → | 3.66 | −103 kJ | 5 |
| Na₃PO₄ + 2Mg + 4H₂ | | | |
| 4LiAlH₄ + 6LiOH → LiAlO₂ + | 7.16 | −352 kJ | 6 |
| 4Li₂O + LiH + 10.5H₂ | | | |

Preferably, the hydrogen storage compositions according to embodiments of the invention generate hydrogen in an exothermic process. As used herein, the term “exothermic” means that heat is released when hydrogen is produced. The hydrogen storage compositions are characterized by no release of hydrogen below the onset temperature; as used herein, the expression “no release of hydrogen” means that less than about 10% of the available hydrogen is released below about 90% of the absolute onset temperature. Heat need only be applied to initiate the pellet; once initiated, the hydrogen generation reaction is self-sustaining and need not be heated continuously during the reaction. Preferably, the hydrogen generation reaction is initiated at a temperature (i.e., the “onset temperature”) between about 313 K to about 773 K, preferably between about 333 K to about 523 K, more preferably between about 373 K to about 473 K, and most preferably between about 393 K to about 453 K. In preferred embodiments, the initiation causes at least one component of the hydrogen storage composition to melt and form a liquid phase such that the hydrogen generation reaction occurs as a solid/liquid or liquid/liquid reaction. As used herein, the term “about” is held to mean within 10% of the stated value.

Exothermic hydrogen storage compositions can further include optional additives such as aluminum, silicon, magnesium, zinc, and lithium.

In an embodiment of a hydrogen generation composition, the at least one chemical hydride and the at least proton source are combined in an admixture such that there are more hydridic hydrogens than protic hydrogens (determined on a molar basis) in the composition, preferably in molar ratios of hydridic hydrogens to protic hydrogens ranging from about 1.005:1 to about 20:1, and more preferably in molar ratios between about 2.5:1 to about 8:1. Preferably, this is achieved when the chemical hydride is present in molar excess relative to the proton source. We have shown that this ratio yields hydrogen storage compositions that combine high hydrogen density—and thus high energy density—with the release of a high percentage of the stored hydrogen.

In a preferred embodiment of a hydrogen generation composition in accordance with the present invention, the at least one chemical hydride comprises lithium aluminum hydride (LiAlH₄ or LAH) and the at least one proton source comprises aluminum hydroxide (Al(OH)₃) or boric acid (B(OH)₃), wherein the lithium aluminum hydride is present in molar excess. Preferably, the hydrogen storage composition comprises LiAlH₄ and Al(OH)₃ combined in a molar ratio of about 1.5 to about 6 moles of LiAlH₄ per mole of hydroxide compound. That is, the hydrogen generation compositions comprise mixtures of LiAlH₄ and Al(OH)₃ in molar ratios ranging from about 1.5 moles of LiAlH₄ per about 1 mole of Al(OH)₃ to about 6 moles of LiAlH₄ per about 1 mole of Al(OH)₃, or mixtures of LiAlH₄ and B(OH)₃ in molar ratios ranging from about 1.5 moles of LiAlH₄: 1 mole of B(OH)₃ to about 6 moles of LiAlH₄: 1 mole of B(OH)₃. A preferred mixture of lithium aluminum hydride and aluminum hydroxide comprises equal masses of both components, which is equivalent to about 2.06 moles of LiAlH₄: 1 mole of B(OH)₃. These compositions have hydridic hydrogens/protic hydrogens ratio ranging from about 6:3 to about 24:3.

For compositions containing a mixture of hydroxides, the molar ratio of hydride to hydroxide compound is preferably maintained at between about 1.5 moles of hydride per about 1 mole of hydroxide compounds to about 6 moles of hydride per about 1 mole of hydroxide compounds as in, for example, mixtures comprising about 1.5 moles of LiAlH₄ per X mole of B(OH)₃ and (1−X) mole of Al(OH)₃ to about 6 moles of LiAlH₄ per X mole of B(OH)₃ and (1−X) mole of Al(OH)₃, wherein X is a number between 0 and 1. For example, equimolar amounts of aluminum hydroxide and boric acid may be combined as the proton source, as in compositions comprising mixtures combined in molar ratios of 2 LiAlH₄, 0.5 B(OH)₃, and 0.5 Al(OH)₃.

In an embodiment of a hydrogen generation composition in accordance with the present invention, a binary mixture of chemical hydrides is combined with at least one proton source. Both of the chemical hydrides contribute hydridic hydrogens, and the total number of hydridic hydrogens is greater than the number of protic hydrogens contributed by the proton source. Preferably, at least one of the chemical hydrides is a boron hydride.

As an exemplary embodiment of a binary chemical hydride composition, the boron hydride is selected from the group of borohydride salts, and the aluminum hydride is selected from the group of aluminum salts combined in a molar ratio of about 2 to about 4 moles of the borohydride salt, about 2 to about 4 moles of the aluminum hydride, and about 1 mole of a proton source. Preferably, the borohydride salt is lithium borohydride, the aluminum salt is lithium aluminum hydride, and the proton source is aluminum hydroxide or boric acid.

In an exemplary embodiment of a binary chemical hydride composition of the present invention, the boron hydride is an ammonia borane, and is preferably NH₃BH₃, and the other chemical hydride is selected from the group consisting of LiAlH₄, NaBH₄, LiBH₄, NaAlH₄, LiH, NaH, LiB₃H₈, NaB₃H₈, and MgH₂. The ammonia borane is provided in molar excess relative to the second chemical hydride, and the hydrogen storage composition comprises an ammonia borane, a second chemical hydride, and a proton source combined in a molar ratio of about 1 to about 16 moles of the ammonia borane, about 1 to about 2 moles of the second chemical hydride, and about 1 mole of the proton source.

As an exemplary embodiment of a binary chemical hydride composition comprising an ammonia borane, the ammonia borane is NH₃BH₃, the second chemical hydride is lithium aluminum hydride (LiAlH₄) and the at least one proton source comprises aluminum hydroxide (Al(OH)₃) or boric acid (B(OH)₃). Preferably, the hydrogen storage composition comprises NH₃BH₃, LiAlH₄ and Al(OH)₃ combined in a molar ratio of about 2 to about 16 moles of NH₃BH₃, about 1 to about 2 moles of LiAlH₄, and about 1 mole of hydroxide compound; these compositions have hydridic hydrogens/protic hydrogens ratio ranging from about 1:0.2 to about 1.7:1.

In another exemplary embodiment of a hydrogen generation composition in accordance with the present invention, a ternary mixture of chemical hydrides is combined with at least one proton source. Preferably, the ternary chemical hydride mixture comprises at least one boron hydride, at least one aluminum hydride, and at least one ionic hydride salt. All of the chemical hydrides contribute hydridic hydrogens such that the total number of hydridic hydrogens is greater than the number of protic hydrogens contributed by the proton source.

In an exemplary embodiment, the boron hydride is an ammonia borane, and more preferably, the boron hydride is NH₃BH₃. The ionic hydride salt can be provided in a molar ratio of about 0.5 to about 4 moles per mole of ammonia borane.

As another exemplary embodiment of a ternary chemical hydride composition, the boron hydride comprises NH₃BH₃, the aluminum hydride comprises lithium aluminum hydride (LiAlH₄), the ionic hydride salt comprises LiH, and the at least one proton source comprises aluminum hydroxide (Al(OH)₃) or boric acid (B(OH)₃). Preferably, the hydrogen storage composition comprises NH₃BH₃, LiAlH₄, LiH, and Al(OH)₃ combined in a molar ratio of about 1 mole of NH₃BH₃, about 1 to about 2 moles of LiAlH₄, about 1 to 3 moles of LiH, and about 1 mole of hydroxide compound. These compositions have hydridic hydrogens/protic hydrogens ratio ranging from about 1.3:1 to about 2.3:1.

Fuel compositions in accordance with embodiments of the present invention are preferably packaged in a fuel cartridge or other storage device that can provide hydrogen to a power module comprising a fuel cell or hydrogen-burning engine for conversion to energy, or to a hydrogen storage device such as a hydrogen cylinder, a metal hydride, or a balloon.

The fuel cartridge or device according to an embodiment of the invention controls hydrogen release from the fuel compositions using an array of fuel compartments and thermal initiators, in which the fuel compartments are separated from each other. The fuel compartments may be completely filled with the fuel composition, or there may be void space within the fuel compartment The amount and composition of the fuel composition can be varied among the fuel compartments within a fuel cartridge. Hydrogen is generated from the fuel compositions when heat is applied, preferably by initiating at least one compartment at a time. Multiple compartments can be initiated at the same time to achieve variable hydrogen generation rates or generated gas volumes. The initiation can be achieved, for example, by heating the compartment as a whole, or by a heating element in contact with the fuel compositions. Initiation elements suitable for use in the invention include, but are not limited to, resistance heaters, nickel-chromium resistance wires, spark igniters, thermistors, and heat exchangers, among others. The fuel cartridges can further contain transducers or other measurement devices such as thermocouples or pressure gauges and can monitor system parameters including, but not limited to, temperature and pressure.

Preferably, the fuel compartments are thermally isolated from each other such that the thermal initiation of a given pellet does not cause a neighboring fuel compartment to also initiate. The separating walls may be a thermal insulator or may conduct some heat as long as its thermal conductivity does not result in the transfer of enough thermal energy to initiate neighboring fuel compartments.

In preferred embodiments, at least a portion of a wall of the fuel compartment is porous and configured to allow the hydrogen generated within each fuel compartment to pass into the fuel cartridge while retaining the pre- and post-reaction solids with the fuel compartment. The porous volume may also be used to store hydrogen within the cartridge. The fuel compartments can be tubes, or formed as compartments within a material. As used herein, the term “tube” is not limited to circular forms and structures, and can include, for example, hexagonal tubes or structures, among others. Suitable materials for forming fuel compartments include glass, ceramics, plastics, polymers, aerogels, and xerogels, among many others.

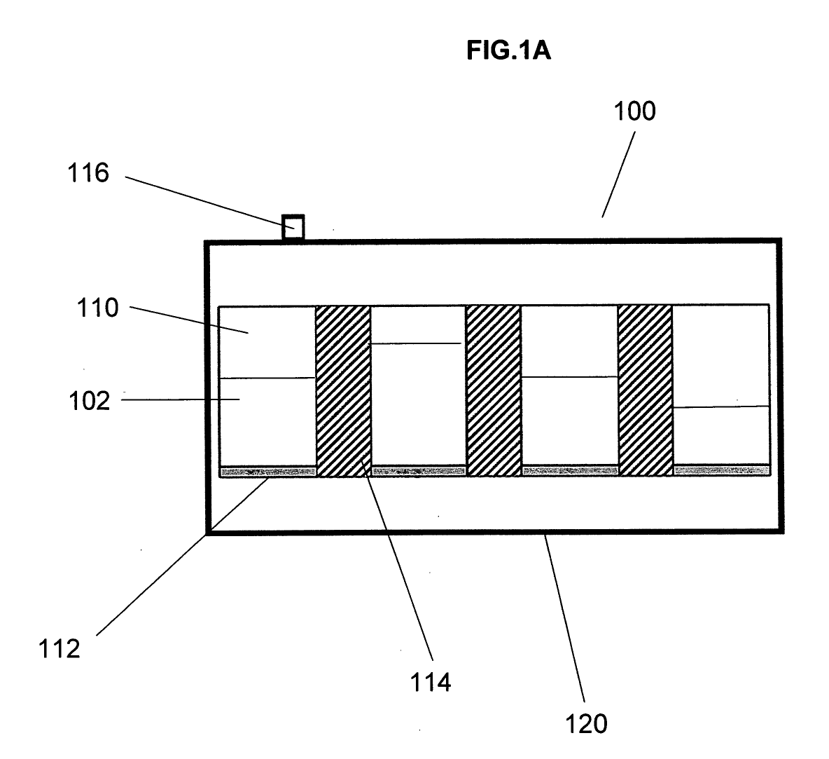

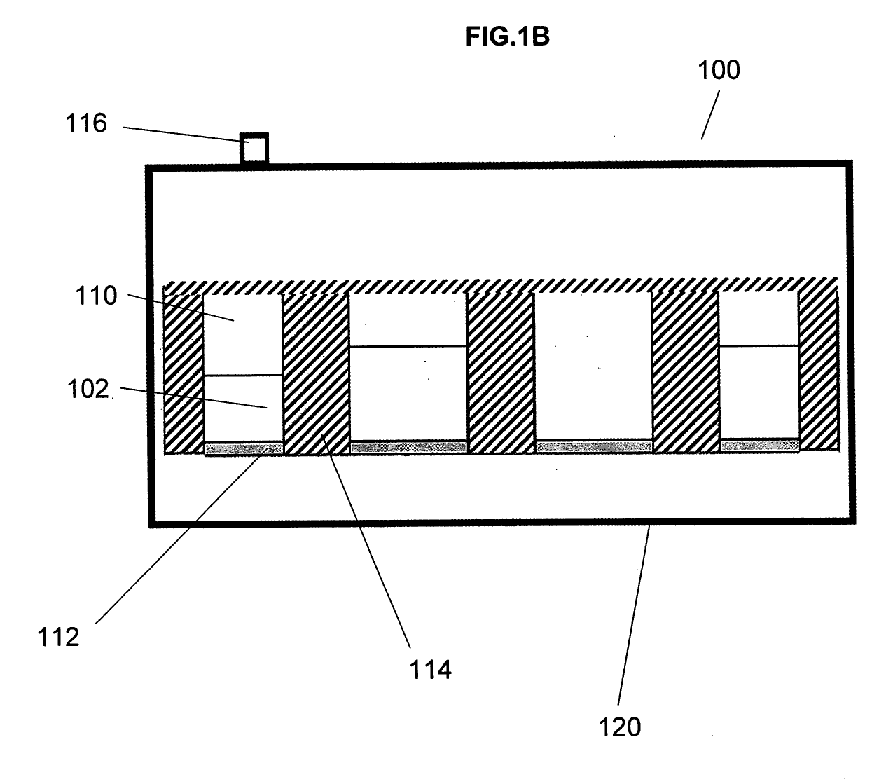

Referring now to FIGS. 1A and 1B, an exemplary fuel cartridge 100 according to an exemplary embodiment of the present invention comprises a plurality of fuel compartments 110 separated by walls 114 and disposed within a housing 120. The fuel cartridge 100 can be equipped with an optional hydrogen outlet 116 to supply hydrogen to a hydrogen-consuming or hydrogen storage device. In some embodiments, a fuel cell may be contained within the fuel cartridge and the optional hydrogen outlet 116 would not be required; such a cartridge can contain gas conduits within the cartridge to provide hydrogen to the anode of the fuel cell.

The walls 114 are configured to allow the hydrogen generated within each fuel compartment to pass into the fuel cartridge while retaining the pre- and post-reaction solids with the fuel compartment 110. The walls 114 may bound the fuel compartments 110 on multiple sides, and can be located, for instance, on the terminal ends of a row of fuel compartments as well as across the top of individual fuel compartments, as illustrated in FIG. 1B. Preferably, the walls 114 at least physically separate individual fuel compartments from each other. Preferably, the fuel compartment walls have a porosity of at least 10%, more preferably at least 20%, and most preferably at least 50%. Examples of suitable materials for the porous walls 114 include glass, ceramics, plastics, polymers, aerogels, and xerogels, among others.

Each fuel compartment preferably contains at least one fuel composition 102 preferably compacted into a form such as a pill or a pellet, though other solid forms can be used. The amount or formulation of the fuel composition 102 in each of the fuel compartments need not be the same, and can be varied to produce different amounts of hydrogen from different fuel compartments, for example.

The composition 102 within each fuel compartment is in contact with an initiation element 112, such as a resistance heater, a nickel-chromium resistance wire, thermistor, spark igniter, or a heat exchanger, for example, that can be individually controlled. The relative location of the initiation element 112 within the fuel compartment is not limited; that is, it may be located anywhere within the fuel compartment as long as it is in contact with at least a portion of the fuel composition 102. Hydrogen is produced from a fuel composition when thermal energy is provided to the composition 102 by the initiation element 112. Hydrogen can be removed from the fuel cartridge to, for example, a fuel cell, via an optional hydrogen outlet 116, and the cartridge may further include hydrogen flow regulating mechanisms that condition the hydrogen to a desired temperature and pressure such as heat exchangers, pressure regulators, and gas scrubbers or filters.

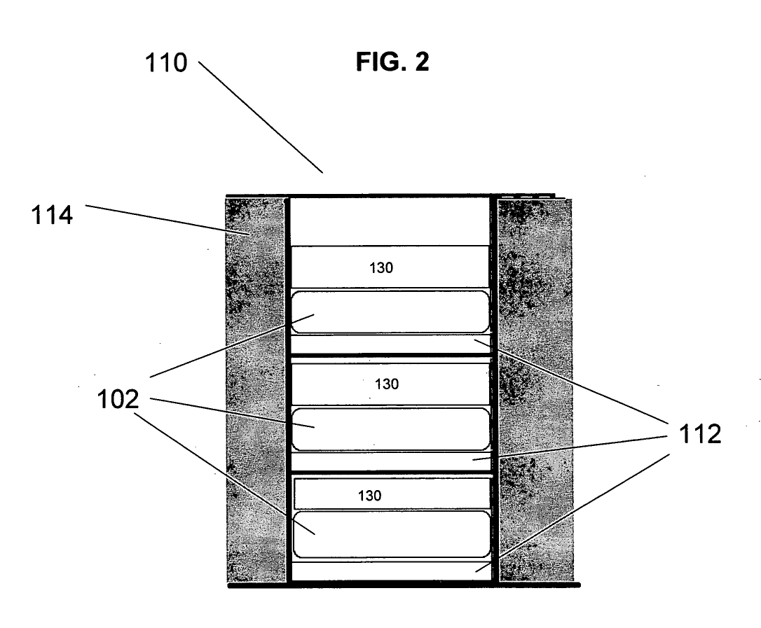

Multiple fuel compositions 102 packaged as discrete “doses” can be located within a single fuel compartment. Referring to FIG. 2, wherein features that are similar to those shown in previous figures have like numbering, an exemplary fuel compartment 110 containing a plurality of pellets of a fuel composition 102 comprises a plurality of initiation elements 112 and a plurality of insulators 130. The term “doses” as used herein means a measured quantity of a fuel composition 102. The dose may be formed into a pellet, pill, or other shape, or can be any quantity of powder material. Preferably, each dose is in contact with a separate initiation element and separated from one another by a spacer 130; the initiation element can be embedded within a dose. Preferably, the spacers 130 permit hydrogen gas to pass through and are comprised of glass, ceramics, cellulose, minerals, xerogels or aerogels, for example. The spacers can be configured as textiles, fabrics, tapes, strips, boards, or papers, among others. Examples of useful materials for spacers include, but are not limited to, boron nitride, high alumina ceramics, zirconium phosphate ceramics, alumina bisque, alumina silicate, glass mica, silica, alumina, zirconia, fiberglass, vermiculite-coated fiberglass, mineral-treated fiberglass, silicone-coated fiberglass, carbon fabric, high alumina fabric, silica fabric, calcium silicate, millboard, chromia, tin oxide, and carbon.

The individual doses within a fuel compartment may be initiated individually, for example, sequentially in a consecutive manner (in an “outside in” fashion wherein the outermost doses at either end are initiated before any of the internal doses; or in an “inside out” fashion wherein the innermost doses are initiated before any of the outer doses). The doses can be initiated in a “coldest” first arrangement; after the initiation of a first dose, hydrogen generation proceeds by initiation of the dose at the lowest temperature within the fuel compartment. Alternatively, the initiation sequence can proceed by a “warmest” first arrangement in which hydrogen generation proceeds by initiation of the dose closest to a specified temperature within the fuel compartment. For arrangements comprising a plurality of doses of different sizes, preferably the relatively smaller doses are dispersed between the relatively larger doses and are initiated before the larger doses.

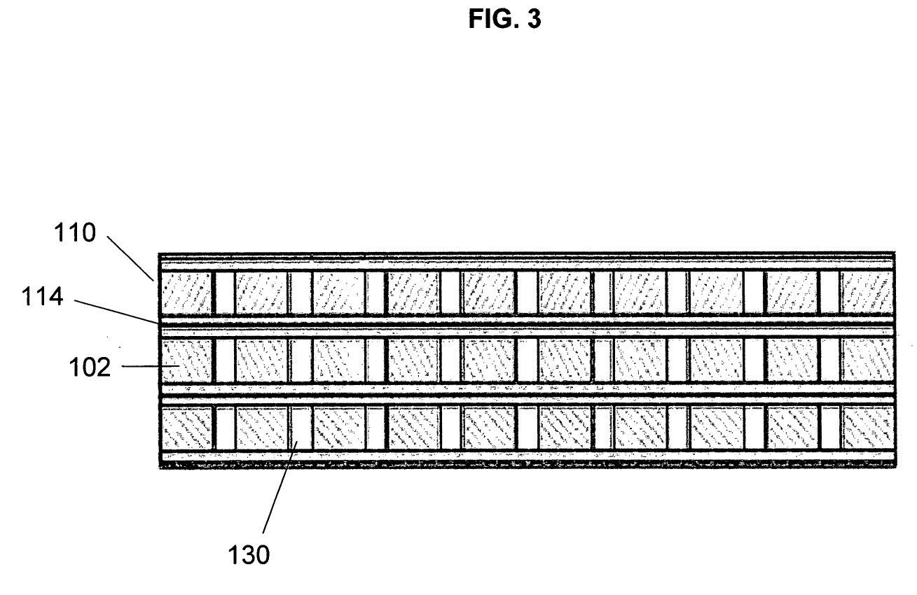

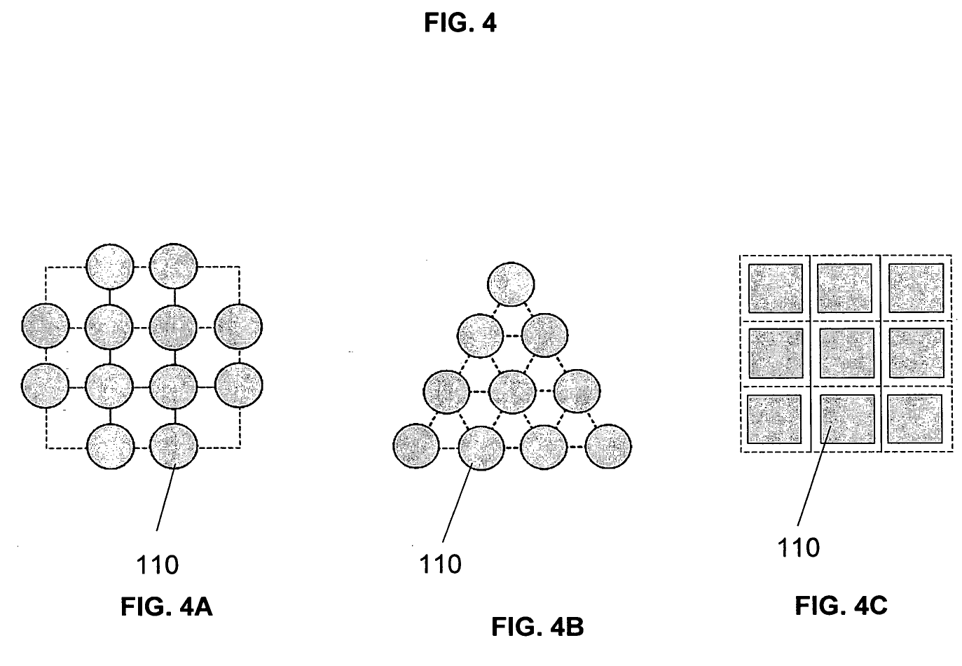

While the fuel compartments 110 in FIGS. 1A and 1B are illustrated in a single layer linear configuration, fuel compartments in this and other embodiments can be packaged within a fuel cartridge in a variety of orientations, including, for example, circular or hexagonal configurations, or in multiple layers as shown in FIG. 3, or those exemplary packing arrangements shown in FIG. 4: cylinders in a square arrangement, cylinders in a triangular arrangement, and square prisms in a square arrangement. The spacing between the fuel compartments would comprise spacers 114.

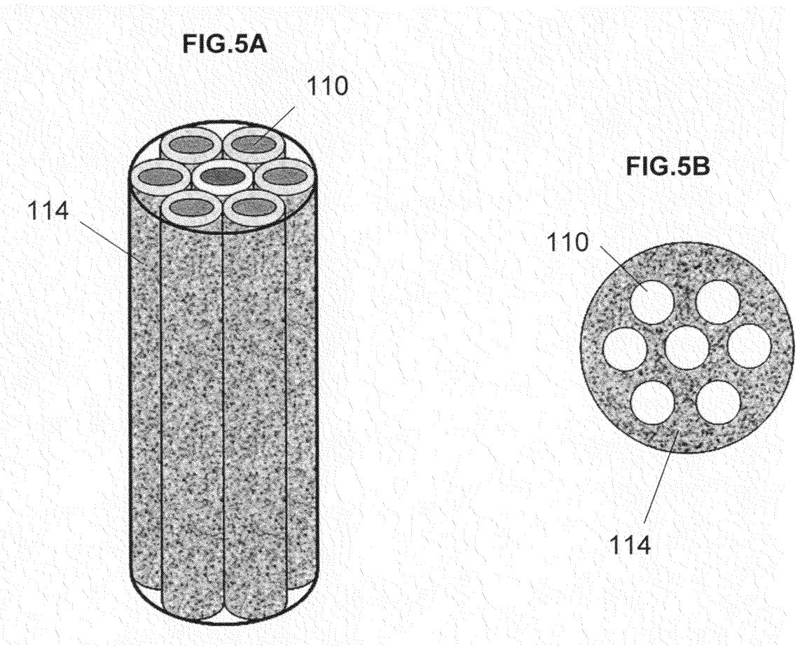

Referring now to FIG. 5, a tubular arrangement of fuel compartments in accordance with another exemplary embodiment of the present invention comprises a plurality of tubular fuel compartments 110 bounded by porous walls 118. The individual compartments may be circular (as shown in FIG. 5) or hexagonal or may have any suitable combination of these configurations, or of other additional configurations. The tubular fuel compartments may be a series of separate tubes or a porous framework, such as a porous ceramic, for example, with bored out reaction compartments. The hydrogen generated will permeate through the porous walls and accumulate within the volume within the cartridge, and may use void volume within the tubes. Each tubular fuel compartment 110 preferably contains at least one fuel composition 102 in communication with at least one initiation element; a plurality of doses may be disposed within each tubular fuel compartment wherein each dose is in contact with a separate initiation element and separated from one another by an insulator 130.

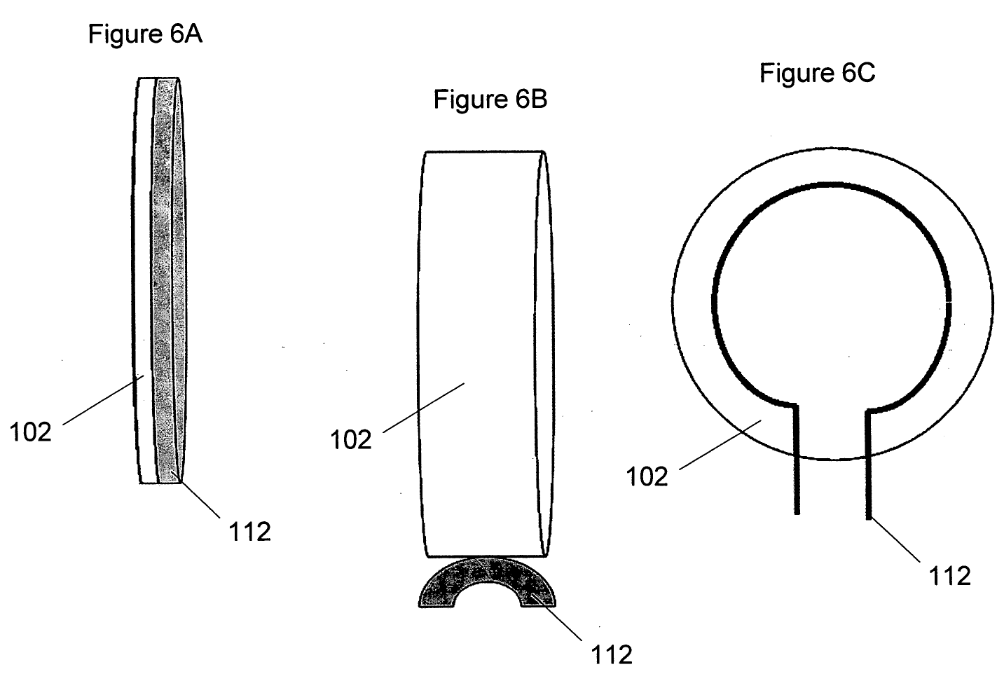

In reference to the illustrated embodiments, the initiation element 112 has been shown as a plate that resides in the stack with pellets of the exothermic fuel composition (for example, as shown in FIG. 6A). Other exemplary arrangements of initiation elements and pellets of the exothermic fuel composition useful in these and other embodiments of the invention are presented in FIG. 6. In some embodiments, the initiation element 112 need only contact a portion of the pellet to initiate complete reaction; we have determined that an initiation element 112, such as a resistance heater, touching the surface of a pellet of an exothermic fuel composition (such as one containing LiAlH₄ and Al(OH)₃ in about 2:1 molar ratio) as shown in FIG. 6B initiated the reaction of the entire pellet. The initiation element 112 can alternatively be a wire that is in contact with a face of a pellet (FIG. 6C). When the exothermic fuel composition is present as a powder or other non-pellet form, the initiation element need only contact a portion of the fuel.

In reference to these and other embodiments of the invention, the fuel compartments within a fuel cartridge may be initiated individually, sequentially in a consecutive manner; in an “outside in” fashion wherein the outermost fuel compartments are discharged before any of the internal fuel compartments; or in an “inside out” fashion wherein the innermost fuel compartments are initiated before any of the outer fuel compartments. Alternatively, fuel compartments may be initiated in a diagonal pattern or similar approach to maximize the distance between consecutive discharged compartments. The fuel compartments can be initiated in a “coldest” first arrangement; after the initiation of a first compartment (or compartments, if multiple compartments are initiated simultaneously), hydrogen generation proceeds by initiation of the fuel compartment at the lowest temperature within the cartridge. Alternatively, the initiation sequence can proceed by a “warmest” first arrangement in which hydrogen generation proceeds by initiation of the fuel compartment closest to a specified temperature within the cartridge.

A “fuel gauging” feature can be incorporated into fuel cartridges according to the disclosed and other embodiments of the present invention to indicate the number of unused compartments—and thus how much energy—remains in the device by including a controller to monitor the number of compartments which have been heated and used. Each compartment is typically initiated one time, after which it will not produce any more hydrogen. Within the control architecture, the controller will monitor which compartments have been used and which have not, as well as the total number of compartments, so that it can initiate the next reaction in the proper place. An exemplary fuel gauge can report a completion percentage indicating the remaining fuel by computing the number of compartments that have been used divided by the total number of compartments. For example, if the device contains 100 compartments, and 53 have been used, then the cartridge is 53% spent (or has 47% of energy remaining).

The following examples further describe and demonstrate features of the compositions and methods for hydrogen generation according to the present invention. The examples are given solely for illustration purposes and are not to be construed as a limitation of the present invention. Various other approaches will be readily ascertainable to one skilled in the art given the teachings herein.

### EXAMPLE 1

A mixture of 2 equivalents of lithium aluminum hydride (about 58.8 mg, 1.550 mmol) and 1 equivalent of aluminum hydroxide (about 60.0 mg, 0.775 mmol) were combined and ground by hand under an argon atmosphere inside a dry box. The mixture was then placed into a press and compressed into a pellet with a diameter of about 12 mm and a height of about 1 mm. The compressed pellet was placed within a porous ceramic holder and the assembly placed within a stainless steel reactor equipped with an inlet, outlet, pressure transducer, pressure relief valve, and an initiation assembly, which consisted of a nickel-chromium wire (about 40 AWG and about 5 cm long) and electrode leads. The center of the nickel-chromium initiation wire was in contact with the pellet while the ends of the initiation wire were clamped to the electrode leads with alligator clips. Once the reactor was sealed, it was removed from the dry box and attached to an argon gas supply, a potentiostat, and an exit-line with an in-line electronic mass flow meter and a volume displacement apparatus to measure the amount of hydrogen gas evolved. The system was degassed with argon for about 30 minutes. The reactor was sealed at about 1 atm by closing both the inlet and outlet valves, and a current of about 0.68 A was applied to produce between about 4.08 and about 4.76 W of power in the initiation wire. The resulting hydrogen gas from the pellet was first measured via the pressure transducer within the reactor. Upon the reactor cooling to room temperature, the hydrogen pressure was released via the outlet to the volume displacement apparatus through the electronic mass flow meter. The amount of hydrogen gas evolved was measured to be about 87.4 mL (92% yield).

### EXAMPLE 2

Using the hydrogen generation procedure described in Example 1, mixtures of ammonia borane (NH₃BH₃) and lithium aluminum hydride as the hydridic species were combined with aluminum hydroxide and boric acid as the protic species in the proportions provided in Table 2, and evolved hydrogen in yields from about 50% to about 90%.

TABLE 2

| | | | | Effective |
|---|---|---|---|---|
| Molar Ratios | | | Percent H₂ | H₂ Stored |
| AB | LAH | Hydroxide | Produced % | wt-% |

Al(OH)₃

| | | | | |
|---|---|---|---|---|
| 2 | 2 | 1 | 89 | 9.50 |
| 2 | 1 | 1 | 86 | 9.20 |
| 4 | 2 | 1 | 79 | 9.97 |
| 4 | 1 | 1 | 64 | 8.29 |
| 16 | 2 | 1 | 49 | 8.09 |

B(OH)₃

| | | | | |
|---|---|---|---|---|
| 2 | 2 | 1 | 87 | 10.04 |
| 4 | 2 | 1 | 78 | 10.45 |
| 8 | 2 | 1 | 57 | 8.74 |

AB = ammonia borane (NH₃BH₃),
LAH = LiAlH₄

While the present invention has been described with respect to particular disclosed embodiments, it should be understood that numerous other embodiments are within the scope of the present invention. Accordingly, it is not intended that the present invention be limited to the illustrated embodiments, but only by the appended claims.

What is claimed as new and desired to be protected by Letters Patent of the United States is:

1. A solid fuel composition for generating hydrogen comprising:
at least one chemical hydride comprising at least one hydridic hydrogen; and
at least one proton source comprising at least one protic hydrogen,
wherein the hydridic hydrogen and protic hydrogen, respectively, are present in the solid fuel composition in a molar ratio of greater than 1:1.

2. The composition according to claim 1, wherein the molar ratio of hydridic hydrogens to protic hydrogens ranges from about 1.005:1 to about 20:1.

3. The composition according to claim 2, wherein the molar ratio of hydridic hydrogens to protic hydrogens ranges from about 2.5:1 to about 8:1.

4. The composition according to claim 1, wherein the at least one chemical hydride is selected from the group consisting of boron hydrides, ionic hydride salts, and aluminum hydrides.

5. The composition according to claim 4, wherein the chemical hydride is a boron hydride selected from the group consisting of borohydride salts [M(BH₄)ₙ], triborohydride salts [M(B₃H₈)ₙ], decahydrodecaborate salts [M₂(B₁₀H₁₀)ₙ], tridecahydrodecaborate salts [M(B₁₀H₁₃)ₙ], dodecahydrododecaborate salts [M₂(B₁₂H₁₂)ₙ], and octadecahydroicosaborate salts [M₂(B₂₀H₁₈)ₙ], where M is an alkali metal cation, alkaline earth metal cation, aluminum cation, zinc cation, or ammonium cation, and n is equal to the charge of the cation.

6. The composition according to claim 4, wherein the chemical hydride is a boron hydride selected from the group consisting of decaborane (14) (B₁₀H₁₄) and tetraborane (10) (B₄H₁₀).

7. The composition according to claim 4, wherein the chemical hydride is an ammonia borane selected from the group consisting of compounds of formula NHₓBH_{y} and NHₓRBH_{y}, wherein x and y are independently an integer from 1 to 4 and do not have to be the same, and R is a methyl or ethyl group; NH₃B₃H₇; and NH(CH₃)₂BH₃.

8. The composition according to claim 4, wherein the chemical hydride is an ionic hydride selected from the group consisting of hydrides of alkali metals, alkaline earth metals, and zinc metal having the general formula MHₙ wherein M is a cation selected from the group consisting of alkali metal cations, alkaline earth metal cations, and zinc(II) and n is equal to the charge of the cation.

9. The composition according to claim 4, wherein the chemical hydride is an aluminum hydride selected from the group consisting of alane and aluminum hydride salts.

10. The composition according to claim 9, wherein the aluminum hydride salts have the formula M(AlH₄)ₙ, where M is an alkali metal cation, alkaline earth metal cation, aluminum cation, zinc cation, or ammonium cation, and n is equal to the charge of the cation.

11. The composition according to claim 1, wherein the at least one proton source is selected from the group consisting of hydroxide salts of alkali and alkaline earth metals, and hydroxide compounds of Group 13 elements.

12. The composition according to claim 11, wherein the proton source is aluminum hydroxide or boric acid.

13. The composition according to claim 1, wherein the at least one proton source is selected from the group consisting of alkali metal dihydrogen phosphate salts; alkali metal dihydrogen citrate salts; sulfate salts of alkali and alkaline earth metals, phosphate salts of alkali and alkaline earth metals; and compounds of formula My[OₚX(OH)_{q}]ₙ where M is an alkali metal or NH₄, q is an integer from 0 to 3, p is an integer from 0 to 3, y is the valence of the anion [OₚX(OH)_{q}], n is the valence of M, and X is S, P, or Se.

14. The composition according to claim 1, wherein the at least one proton source is selected from the group consisting of alcohols, polymeric alcohols, silicates, silica sulfuric acid, acid chloride compounds, hydrogen sulfide, and amines.

15. The composition according to claim 1, further comprising aluminum, magnesium, silicon, zinc, or lithium.

16. A solid fuel composition for generating hydrogen comprising:
at least one aluminum hydride, wherein the at least one aluminum hydride comprises at least one hydridic hydrogen; and
at least one hydroxide compound selected from the group consisting of hydroxide salts of alkali and alkaline earth metals, and hydroxide compounds of Group 13 elements, wherein the at least one hydroxide compound comprises at least one protic hydrogen, and wherein there are more hydridic hydrogens than protic hydrogens in the composition on a molar basis.

17. The composition according to claim 16, wherein the aluminum hydride is selected from the group consisting of alane and the aluminum hydride salts having the formula M(AlH4)n, where M is an alkali metal cation, alkaline earth metal cation, aluminum cation, zinc cation, or ammonium cation, and n is equal to the charge of the cation.

18. The composition according to claim 17, comprising lithium aluminum hydride and aluminum hydroxide in a molar ratio of about 1.5 moles to about 6 moles of lithium aluminum hydride per about 1 mole of aluminum hydroxide.

19. The composition according to claim 18, comprising lithium aluminum hydride and aluminum hydroxide in a molar ratio of about 2 moles of lithium aluminum hydride to about 1 mole of aluminum hydroxide.

20. The composition according to claim 18, comprising lithium aluminum hydride and aluminum hydroxide in a molar ratio of about 2.06 moles of lithium aluminum hydride to about 1 mole of aluminum hydroxide.

21. The composition according to claim 18, comprising lithium aluminum hydride and aluminum hydroxide in a molar ratio of about 3 moles of lithium aluminum hydride to about 1 mole of aluminum hydroxide.

22. The composition according to claim 18, comprising lithium aluminum hydride and aluminum hydroxide in a molar ratio of about 4 moles of lithium aluminum hydride to about 1 mole of aluminum hydroxide.

23. The composition according to claim 17, comprising lithium aluminum hydride and aluminum hydroxide in a molar ratio of about 1.5 moles to about 6 moles of lithium aluminum hydride per about 1 mole of boric hydroxide.

24. The composition according to claim 23, comprising lithium aluminum hydride and boric hydroxide in a molar ratio of about 4 moles of lithium aluminum hydride to about 1 mole of boric hydroxide.

25. The composition according to claim 23, comprising lithium aluminum hydride and boric hydroxide in a molar ratio of about 3 moles of lithium aluminum hydride to about 1 mole of boric hydroxide.

26. The composition according to claim 23, comprising lithium aluminum hydride and boric hydroxide in a molar ratio of about 2 moles of lithium aluminum hydride to about 1 mole of boric hydroxide.

27. The composition according to claim 16, further comprising an ionic hydride selected from the group consisting of hydrides of alkali metals, alkaline earth metals, and zinc metal having the general formula MHₙ, wherein M is a cation selected from the group consisting of alkali metal cations, alkaline earth metal cations, and zinc(II), and n is equal to the charge of the cation.

28. The composition according to claim 16, further comprising a boron hydride selected from the group consisting of borohydride salts [M(BH₄)ₙ], triborohydride salts [M(B₃H₈)ₙ], decahydrodecaborate salts [M₂(B₁₀H₁₀)ₙ], tridecahydrodecaborate salts [M(B₁₀H₁₃)ₙ], dodecahydrododecaborate salts [M₂(B₁₂H₁₂)ₙ], and octadecahydroicosaborate salts [M₂(B₂₀H₁₈)ₙ], where M is an alkali metal cation, alkaline earth metal cation, aluminum cation, zinc cation, or ammonium cation, and n is equal to the charge of the cation.

29. The composition according to claim 28, comprising lithium borohydride, lithium aluminum hydride and aluminum hydroxide in a molar ratio of about 1 to about 4 moles of lithium borohydride to about 1 to about 4 moles of lithium aluminum hydride to about 1 mole of aluminum hydroxide.

30. The composition according to claim 29, comprising lithium borohydride, lithium aluminum hydride and aluminum hydroxide in about 1:1:1 molar ratio.

31. The composition according to claim 29, comprising lithium borohydride, lithium aluminum hydride and aluminum hydroxide in about 2:1:1 molar ratio.

32. The composition according to claim 28, comprising lithium borohydride, lithium aluminum hydride and boric acid in a molar ratio of about 1 to about 4 moles of lithium borohydride to about 1 to about 4 moles of lithium aluminum hydride to about 1 mole of boric acid.

33. The composition according to claim 32, comprising lithium borohydride, lithium aluminum hydride and boric acid in about 1:1:1 molar ratio.

34. The composition according to claim 32, comprising lithium borohydride, lithium aluminum hydride and boric acid in about 2:1:1 molar ratio.

35. A solid fuel composition for generating hydrogen comprising in admixture at least one chemical hydride, an ammonia borane, and at least one hydroxide compound selected from the group consisting of hydroxide salts of alkali and alkaline earth metals, and hydroxide compounds of Group 13 elements.

36. The composition according to claim 35, wherein the at least one chemical hydride is selected from the group consisting of alane and aluminum hydride salts having the formula M(AlH₄)ₙ, where M is an alkali metal cation, alkaline earth metal cation, aluminum cation, zinc cation, or ammonium cation, and n is equal to the charge of the cation.

37. The composition according to claim 36, wherein the aluminum hydride is LiAlH₄ or NaAlH₄.

38. The composition according to claim 35, wherein the at least one chemical hydride is selected from the group consisting of borohydride salts [M(BH₄)ₙ], triborohydride salts [M(B₃H₈)ₙ], decahydrodecaborate salts [M₂(B₁₀H₁₀)ₙ], tridecahydrodecaborate salts [M(B₁₀H₁₃)ₙ], dodecahydrododecaborate salts [M₂(B₁₂H₁₂)ₙ], and octadecahydroicosaborate salts [M₂(B₂₀H₁₈)ₙ], where M is an alkali metal cation, alkaline earth metal cation, aluminum cation, zinc cation, or ammonium cation, and n is equal to the charge of the cation.

39. The composition according to claim 38, wherein the borohydride salt is selected from the group consisting of NaBH₄, LiBH₄, LiB₃H₈, and NaB₃H₈.

40. The composition according to claim 35, wherein the at least one chemical hydride is an ionic hydride selected from the group consisting of hydrides of alkali metals, alkaline earth metals, and zinc metal having the general formula MHₙ, wherein M is a cation selected from the group consisting of alkali metal cations, alkaline earth metal cations, and zinc(II), and n is equal to the charge of the cation.

41. The composition according to claim 40, wherein the ionic hydride is selected from the group consisting of LiH, NaH, ZnH₂, and MgH₂.

42. The composition according to claim 40, wherein the ionic hydride is present in a molar ratio of about 0.05 to about 4 moles per mole of ammonia borane.

43. The composition according to claim 35, wherein the ammonia borane is selected from the group consisting of compounds of formula NHₓBH_{y} and NHₓRBH_{y}, wherein x and y are independently an integer from 1 to 4 and do not have to be the same, and R is a methyl or ethyl group; NH₃B₃H₇; and NH(CH₃)₂BH₃.

44. The composition according to claim 43, comprising NH₃BH₃, lithium aluminum hydride, and aluminum hydroxide in a molar ratio of about 1 to about 60 moles of ammonia borane to about 1 mole of lithium aluminum hydride to about 1 mole of aluminum hydroxide.

45. The composition according to claim 43, comprising NH₃BH₃, lithium aluminum hydride, and aluminum hydroxide in a molar ratio of about 1 to about 60 moles of ammonia borane to about 2 moles of lithium aluminum hydride to about 1 mole of aluminum hydroxide.

46. The composition according to claim 43, comprising NH₃BH₃, lithium aluminum hydride, and aluminum hydroxide in a molar ratio of about 1 to about 60 moles of ammonia borane to about 3 moles of lithium aluminum hydride to about 1 mole of aluminum hydroxide.

47. The composition according to claim 43, comprising NH₃BH₃, lithium aluminum hydride, and aluminum hydroxide in a molar ratio of about 1 to about 60 moles of ammonia borane to about 4 moles of lithium aluminum hydride to about 1 mole of aluminum hydroxide.

48. The composition according to claim 43, comprising NH₃BH₃, lithium aluminum hydride, and boric acid.

49. A process for generating hydrogen, comprising:
providing a mixture of at least one chemical hydride comprising at least one hydridic hydrogen, and at least one proton source comprising at least one protic hydrogen, the at least one chemical hydride and the at least one proton source being combined such that there are more hydridic hydrogens than protic hydrogens in the composition on a molar basis; and
thermally initiating the mixture to generate hydrogen.

50. The process of claim 49, further comprising heating at least a portion of the mixture to a temperature of between about 313 K to about 773 K.

51. The process of claim 50, wherein the temperature is between about 373 K to about 473 K.

52. The process of claim 50, wherein the temperature is between about 393 K to about 453 K.

53. A fuel cartridge comprising:
a housing;
a plurality of fuel compartments disposed within said housing;
at least one initiation element in communication with at least one fuel compartment; and
at least a first hydrogen storage composition disposed within at least one fuel compartment, wherein said first hydrogen storage composition comprises at least one chemical hydride comprising at least one hydridic hydrogen and at least one proton source comprising at least one protic hydrogen, and wherein there are more hydridic hydrogens than protic hydrogens in the composition on a molar basis.

54. The fuel cartridge in accordance with claim 53, further comprising a second hydrogen storage composition disposed within at least one fuel compartment.

55. The fuel cartridge in accordance with claim 53, wherein the first hydrogen storage composition is disposed within a fuel compartment in a plurality of doses, wherein each dose is in contact with an initiation element.

56. The fuel cartridge in accordance with claim 55, wherein the doses are separated from one another by a spacer.

57. The fuel cartridge in accordance with claim 56, wherein the spacer comprises a material selected from the group consisting of glass, ceramics, cellulose, minerals, xerogels and aerogels.

58. The fuel cartridge in accordance with claim 53, wherein the first hydrogen storage composition is disposed within a plurality of fuel compartments.

59. The fuel cartridge in accordance with claim 58, wherein each of the plurality of fuel compartments holds a different amount of the first hydrogen storage composition.

60. The fuel cartridge in accordance with claim 53, further comprising at least one porous wall bounding at least one fuel compartment.

61. The fuel cartridge in accordance with claim 60, wherein said porous wall comprises a material selected from the group consisting of glasses, ceramics, plastics, polymers, aerogels, and xerogels.

62. The fuel cartridge in accordance with claim 60, wherein said porous wall has a porosity of at least 10%.

63. The fuel cartridge in accordance with claim 53, wherein said initiation element is selected from the group consisting of resistance heaters, spark igniters, nickel-chromium resistance wires, thermistors, and heat exchangers.

64. The fuel cartridge in accordance with claim 53, wherein said initiation element is a wire.

65. The fuel cartridge in accordance with claim 53, wherein said initiation element is a plate.

66. The fuel cartridge in accordance with claim 53, wherein said initiation element is in contact with the first hydrogen storage composition.

67. The fuel cartridge in accordance with claim 55, wherein said initiation element is embedded within at least one dose.

68. The fuel cartridge in accordance with claim 53, wherein said fuel compartments are arranged in a plurality of layers.

69. The fuel cartridge in accordance with claim 53, wherein said fuel compartments are cylindrical and arranged in a square arrangement.

70. The fuel cartridge in accordance with claim 53, wherein said fuel compartments are cylindrical and arranged in a triagonal arrangement.

71. The fuel cartridge in accordance with claim 53, wherein said fuel compartments are square prismatic and arranged in a square arrangement.

72. The fuel cartridge in accordance with claim 53, further comprising a fuel cell.

73. A method of controlling generation of hydrogen gas in a fuel cartridge comprising a plurality of fuel compartments containing a fuel which generates hydrogen upon thermal initiation and at least one initiation element in communication with at least one fuel compartment, the method comprising:
activating the at least one initiation element in at least one fuel compartment to provide thermal initiation to generate hydrogen;
detecting at least one temperature at a location within the fuel cartridge; and
activating a second initiation element in another fuel compartment to provide thermal initiation to generate hydrogen based on the detected temperature.

74. The method according to claim 73, wherein the detected temperature indicates a fuel compartment having the lowest temperature among unactivated fuel compartments.

75. The method according to claim 73, wherein the detected temperature indicates a fuel compartment having the highest temperature among unactivated fuel compartments.

76. The method according to claim 73, wherein the detected temperature indicates a fuel compartment having the temperature closest to a specified setting among unactivated fuel compartments.

77. The method according to claim 73, wherein the fuel which generates hydrogen upon thermal initiation comprises an ammonia borane.

78. The method according to claim 73, wherein the fuel which generates hydrogen upon thermal initiation comprises at least one chemical hydride comprising at least one hydridic hydrogen and at least one proton source comprising at least one protic hydrogen, wherein there are more hydridic hydrogens than protic hydrogens in the fuel on a molar basis.
